(19) United States
(12) Patent Application Publication
(10) Pub. No.: US 2017/0163878 A1
(43) Pub. Date: Jun. 8, 2017

(54) METHOD AND ELECTRONIC DEVICE FOR ADJUSTING SHOOTING PARAMETERS OF CAMERA

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Tianyu Jiang, Beijing (CN); Nailei Zhang, Beijing (CN)

(21) Appl. No.: 15/245,043

(22) Filed: Aug. 23, 2016

Related U.S. Application Data
(63) Continuation of application No. PCT/CN2016/088964, filed on Jul. 6, 2016.

(30) Foreign Application Priority Data
Dec. 8, 2015 (CN) 201510896645.2

(51) Int. Cl. H04N 5/232

(52) U.S. Cl. CPC H04N 5/23216; H04N 5/23241; H04N 5/23293

(57) ABSTRACT

This disclosure provides a method and an electronic device for adjusting shooting parameters of a camera, wherein the method comprises: when receiving a camera turning-on instruction, determining a target scenario according to a current shooting environment and setting the current shooting parameters of the camera by using a parameter configuration initial value corresponding to the target scenario; generating a shooting image by using the shooting parameters according to a received shooting instruction; and if it is identified that a shooting abnormity occurs to the camera, adjusting the current shooting parameters of the camera based on a setup parameter adjustment strategy.

### CROSS-REFERENCE TO RELATED APPLICATIONS

The present application is a continuation application of a PCT application No. PCT/CN2016/088964, filed on Jul. 6, 2016; and claims the priority from Chinese patent application No. 2015108966452 filed on Dec. 8, 2015, titled “METHOD AND DEVICE FOR ADJUSTING SHOOTING PARAMETERS OF CAMERA”, the disclosures of all of which are incorporated herein by reference in its entirety.

### TECHNICAL FIELD

The present disclosure relates to image processing technologies, and in particular, to a method and an electronic device for adjusting shooting parameters of a camera.

### BACKGROUND

With the development of mobile terminal technologies, the applications in a mobile terminal such as a mobile phone are increasing, and various mobile terminals become more and more popular. The functions of the existing mobile terminals are no longer limited to the function of calling or watching videos. As one of the functions of most mobile terminals, shooting function becomes more and more important. For some photography enthusiasts, they do not always carry a Single Lens Reflex (SLR) camera at any time and in any place. Therefore, the camera in the carried mobile terminal may often be used for shooting without the presence of the SLR camera if there is a nice view.

However, in performing a shooting function by the camera of the mobile terminal, there will be certain requirements on the shooting effect of the camera. In the technical solution for the shooting adjustment of the camera in the prior art, after the parameters for determining the camera shooting effect are set under the system development environment, the whole adjustment solution is fixed and made in the system layer of the device. However, during the use of a mobile terminal, the shooting parameters of the camera fixed in such a mode cannot be reedited, and if someone wants to modify the shooting parameters of the camera, he/she needs to remanufacture the system firmware of the device, which may cause the inconvenience in system development, debugging and optimization, and hence degrade the adjustment efficiency of the camera. Further, the inflexible modification mode of the shooting parameters of the camera will also weaken the use and the upgrade experience of the camera; additionally, under user application scenarios, the general camera adjustment solution may not be able to reach a good shooting effect.

Therefore, it needs to improve the camera adjustment method, thereby improving the shooting effect of the camera.

### SUMMARY

The present disclosure provides a method and an electronic device for adjusting shooting parameters of a camera, thereby improving the shooting effect of the camera.

In a first aspect, one embodiment of the application provides a method for adjusting shooting parameters of a camera, which includes:

determining a target scenario according to a current shooting environment and setting the current shooting parameters of the camera by using a parameter configuration initial value corresponding to the target scenario, when receiving a camera turning-on instruction;

generating a shooting image by using the current shooting parameters according to a received shooting instruction; and

adjusting the current shooting parameters of the camera based on a setup parameter adjustment strategy when it is identified that a shooting abnormity occurs to the camera.

In a second aspect, one embodiment of this disclosure further provides a non-transitory computer storage medium, on which a computer-executable instruction is stored, wherein the computer-executable instruction is configured for perform any of the above methods for adjusting shooting parameters of a camera according to this disclosure.

In a third aspect, one embodiment of this disclosure further provides an electronic device, which includes: at least one processor; and a memory, on which a program that may be executed by the at least one processor is stored, when executed by the at least one processor, the program can cause the at least one processor to perform any of the above methods for adjusting shooting parameters of a camera according to this disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for adjusting shooting parameters of a camera according to Embodiment 1 of this disclosure;

FIG. 2 is a flow chart of a method for adjusting shooting parameters of a camera according to Embodiment 2 of this disclosure;

FIG. 3 is a flow chart of a method for adjusting shooting parameters of a camera according to Embodiment 3 of this disclosure;

FIG. 4 is a flow chart of a method for adjusting shooting parameters of a camera according to Embodiment 4 of this disclosure;

FIG. 5 is a block diagram of an electronic device for adjusting shooting parameters of a camera according to Embodiment 5 of this disclosure; and

FIG. 6 is a schematic diagram showing the hardware structure of an electronic device according to Embodiment 7 of this disclosure.

### DETAILED DESCRIPTION

This disclosure will be illustrated in detail in conjunction with the drawings and embodiments. It may be understood that, the embodiments described here are only set for explaining, rather than limiting, this disclosure. Additionally, it further needs to be noted that, for convenient description, the drawings only show the parts related to this disclosure, rather than the whole contents.

Before discussing the exemplary embodiments in more detail, it should be noted that some exemplary embodiments are described as processes or methods depicted by a flow chart. Although a plurality of steps are described as sequential processes in the flow chart, many operations therein may be implemented parallelly, concurrently or simultaneously. In addition, the operation sequence may be rearranged. When the operations are completed, the process may be terminated; however, it may further include additional steps that are not included in the drawings. The process may correspond to a method, a method, a function, a procedure, a subroutine and a subprogram, etc.

### Embodiment 1

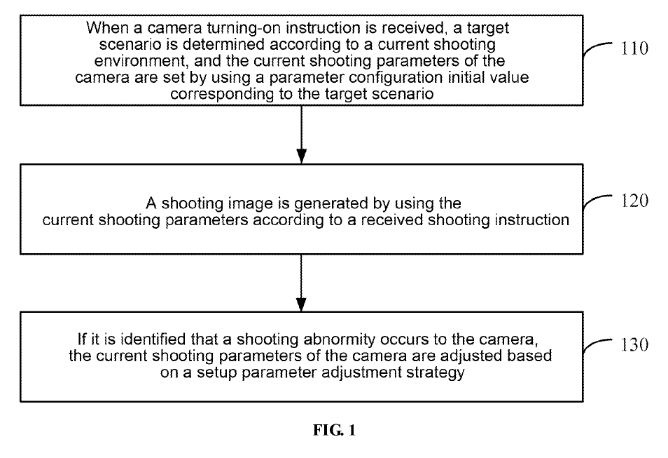

FIG. 1 is a flow chart of a method for adjusting shooting parameters of a camera according to Embodiment 1 of this disclosure. The present embodiment may be applicable to a case in which the intrinsic shooting parameter configuration initial value in the system cannot meet the user's shooting demand and hence it needs to readjust the shooting parameters according to the actual shooting scenario so as to shoot a desirable photo. The method may be performed by an electronic device for adjusting shooting parameters of a camera. The electronic device may be implemented in a hardware and/or software mode, and it may be generally integrated in a terminal device configured with a camera. The method includes the steps of:

Step 110: when a camera turning-on instruction is received, a target scenario is determined according to a current shooting environment, and the current shooting parameters of the camera are set by using a parameter configuration initial value corresponding to the target scenario.

Wherein, the camera may be configured on various mobile terminals such as a mobile phone or a tablet computer, etc. The camera turning-on instruction is issued by a user, and when the user needs to photograph, the user may issue a camera turning-on instruction by initiating an camera application program corresponding to the camera on the mobile terminal. The parameter configuration initial value may be parameter configuration data for being invoked by a camera during shooting, which have been saved in the system in factory setting of the camera and match with certain target scenarios (for example, scenarios of “sunlight”, “night scene” and “fluorescent light”).

For example, the user initiates the camera application program in a bright environment. As the system receives a camera turning-on instruction, it determines a target scenario in the current shooting environment as “sunlight” according to the data received via Image Signal Processing (ISP), and then sets the current shooting parameters of the camera by using the parameter configuration initial value matching with the scenario “sunlight”, in this case, for example, the photosensibility will be set slightly downward; if the user initiates the camera application program in a dim environment, then the system will set the current shooting parameters of the camera by using the parameter configuration initial value matching with the scenario “night scene”, and thus the photosensibility may be set slightly upward, and also the exposure time may be extended.

Optionally, the current shooting parameters of the camera include: focal length, photosensibility, aperture size or shutter time.

Step 120: a shooting image is generated by using the current shooting parameters according to the received shooting instruction.

Wherein, the shooting instruction is issued by the user, and the user may issue the shooting instruction by clicking on a virtual button corresponding to the shooting function on the mobile terminal.

Step 130: if it is identified that a shooting abnormity occurs to the camera, the current shooting parameters of the camera are adjusted based on a setup parameter adjustment strategy.

In the present embodiment, the shooting abnormity of the camera may include: an abnormity of user shooting operation and an abnormity of photographed picture, which may characterize an abnormal situation in which a user is not satisfied with the currently shot photo.

Optionally, the abnormity of user shooting operation may be an abnormity of setup operation of the user during camera turning-on. For example, the number of deleting operations is greater than a set threshold, or the ratio of the number of deleting operations to the number of shooting operations is greater than a set threshold, or the ratio of the number of saving operations to the number of shooting operations is less than a set threshold, etc.

Optionally, the abnormity of photographed picture may be an abnormity in which it is determined, by analyzing the photographed picture during turning-on of the camera, that the setup parameter (for example, the number of noises) in the shooting image exceeds a set threshold.

In the present embodiment, the step in which the current shooting parameters of the camera is adjusted based on a setup parameter adjustment strategy may include: the current shooting parameters of the camera are adjusted according to a local adjustment strategy which is stored on the camera locally and corresponds to the shooting abnormity; or, the current shooting parameters of the camera are adjusted according to a remote adjustment strategy which is obtained by sending the parameters (for example, the number of abnormity shooting operations, abnormal photographed images and shooting parameters of the current camera, etc.) corresponding to the shooting abnormity to a cloud server and returning by a cloud server; or, the current shooting parameters of the camera are adjusted according to both the local adjustment strategy and the remote adjustment strategy.

Optionally, during the turning-on process of the camera, an abnormal shooting image in the shooting images is acquired in real time, and after it is determined that an abnormity of user shooting operation occurs, the current shooting parameters of the camera are adjusted according to the acquired abnormal shooting image.

In the solution for adjusting shooting parameters of a camera according to this disclosure, when a camera turning-on instruction is received, a target scenario is determined according to the current shooting environment, the current shooting parameters of the camera are set by using the parameter configuration initial value corresponding to the target scenario in the system, and a shooting image is generated by using the initial shooting parameter, and when it is identified that shooting abnormity occurs to the camera, the current shooting parameters of the camera will be adjusted based on a setup parameter adjustment strategy, so that it may be adapted for the shooting scenario, the shooting effect may be improved, and an image with which the user is satisfied may be shot, thereby improving user experience, and realizing an individualized shooting.

### Embodiment 2

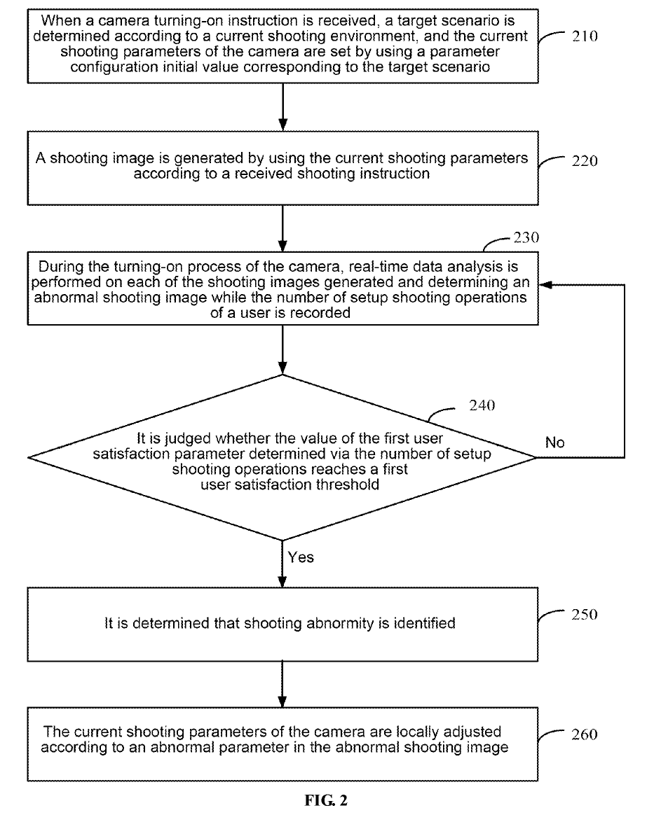

FIG. 2 is flow chart of a method for adjusting shooting parameters of a camera according to Embodiment 2 of this disclosure. The present embodiment is optimized based on Embodiment 1, the occasion for adjusting the shooting parameters may be determined rapidly and accurately by identifying the mode of user operation abnormity. The method includes the steps of:

Step 210: when a camera turning-on instruction is received, a target scenario is determined according to the current shooting environment, and the current shooting parameters of the camera are set by using a parameter configuration initial value corresponding to the target scenario.

Step 220: a shooting image is generated by using the shooting parameters according to the received shooting instruction.

Step 230: during the turning-on process of the camera, real-time data analysis is performed on each of the shooting images generated and an abnormal shooting image is determined while the number of setup shooting operations of a user is recorded.

Wherein, the setup shooting operations include: a deleting operation and/or a saving operation of a user on the generated shooting image;

Optionally, the step in which real-time data analysis is performed on each of the generated shooting images and an abnormal shooting image is determined during the turning-on process of the camera includes: the value of a second user satisfaction parameter in each of the shooting images generated is acquired, wherein, the second user satisfaction parameter includes: the number of noises and/or a white balance; a shooting image with the value of the second user satisfaction parameter reaching a second user satisfaction threshold is taken as an abnormal shooting image, and the second user satisfaction parameter is taken as an abnormal parameter.

For example, a user photographs in a certain dim environment, and it is known that the shooting image has too many noises by performing real-time data analysis on each of the generated shooting images, that is, the second user satisfaction parameter is too high, for example, is 10, and the second user satisfaction threshold is 6; at this point, the second user satisfaction parameter is taken as an abnormal parameter, that is, the number of noises are taken as the abnormal parameter, and the current shooting parameters of the camera are locally adjusted according to the abnormal parameter, so that the number of noises on the shooting image may be lowered.

Step 240: it is judged whether the value of the first user satisfaction parameter determined via the number of setup shooting operations reaches a first user satisfaction threshold; when the value of the first user satisfaction parameter determined via the number of setup shooting operations reaches the first user satisfaction threshold, it turns to Step 250; when the value of the first user satisfaction parameter determined via the number of setup shooting operations does not reach the first user satisfaction threshold, it returns to Step 230;

If the value of the first user satisfaction parameter determined via the number of setup shooting operations reaches a first user satisfaction threshold, it is determined that shooting abnormity is identified.

For example, a user continuously shoots six photos in the same shooting scenario, and deletes five thereof and saves only one of the six photos; at this point, the number of setup shooting operations may be 6, and the value of the first user satisfaction parameter determined via the number of setup shooting operations may be 5/6. Assuming that the first user satisfaction threshold is 0.2, then 5/6 is greater than 0.2, and at this point, it may be determined that shooting abnormity is identified, that is, the user is not satisfied with the photos shot by using the current shooting parameters, and the current shooting parameters need to be adjusted, and then the current shooting parameters of the camera are adjusted based on a setup parameter adjustment strategy.

Step 250: it is determined that shooting abnormity is identified;

Step 260: the current shooting parameters of the camera are locally adjusted according to an abnormal parameter in the abnormal shooting image;

Wherein, the step in which the current shooting parameters of the camera are locally adjusted according to an abnormal parameter in the abnormal shooting image refers to that: for example, a user photographs in a certain dim environment, after the ISP of the camera obtains the parameters of the current shooting environment, the target scenario of the current shooting environment is determined, and as a default, the current shooting parameters of the camera are set by using a parameter configuration initial value corresponding to the target scenario, for example, the photosensibility is locked to ISO6000 (ISO refers to photosensibility, and ISO6000 refers to that the numerical value of the photosensibility is 6000), a shutter is pulled while an Optical Image Stabilizer (OIS) is closed, and the exposure time is adjusted to find a reasonable light flux to accomplish shooting, but the user deletes all the photos after seeing them; in this case, it is determined that a shooting abnormity occurs to the camera, and thus the current shooting parameters of the camera are adjusted based on a setup parameter adjustment strategy, for example, the photosensibility is lowered to ISO2000 (ISO refers to photosensibility, and ISO2000 refers to that the numerical value of the photosensibility is 2000); and further, the exposure time may be extended and it continues to photograph.

In the method for adjusting shooting parameters of a camera according to the present embodiment, it is identified whether an image shot by the camera is abnormal via a first user satisfaction, or it determines an abnormal parameter of a shooting image via a second user satisfaction parameter, and when it is identified that a shooting abnormity occurs to the camera or an abnormal parameter is determined, the current shooting parameters of the camera will be adjusted based on a setup parameter adjustment strategy, or the current shooting parameters of the camera will be adjusted locally according to an abnormal parameter in the abnormal shooting image, so that it may be adapted for the shooting scenario, the shooting effect may be improved, and an image with which the user is satisfied may be shot, thereby improving user experience, and realizing an individualized shooting.

### Embodiment 3

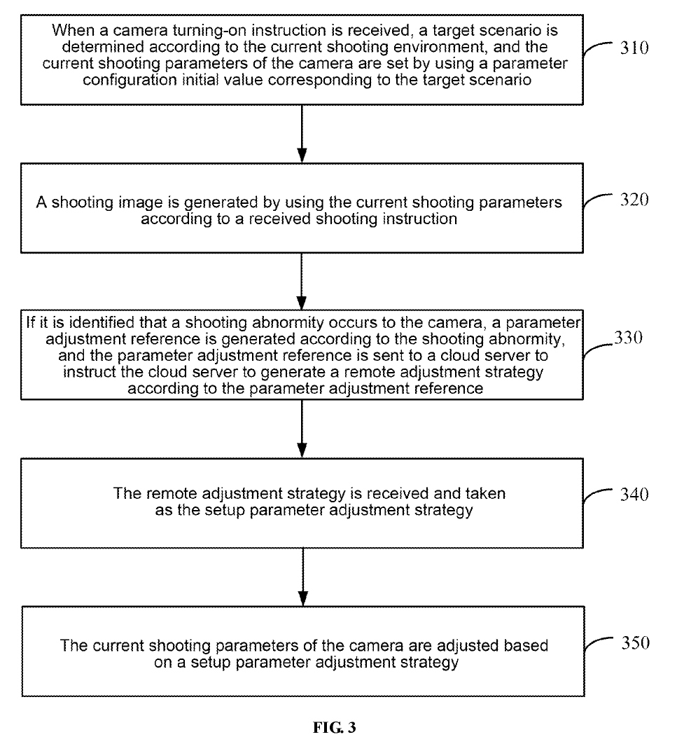

FIG. 3 is a flow chart of a method for adjusting shooting parameters of a camera according to Embodiment 3 of this disclosure. The present embodiment is optimized based on Embodiment 1, so that an optimal strategy for adjusting shooting parameters of a camera may be worked out, thereby the shooting effect may be improved. The method includes the steps of:

Step 310: when a camera turning-on instruction is received, a target scenario is determined according to the current shooting environment, and the current shooting parameters of the camera are set by using a parameter configuration initial value corresponding to the target scenario.

Step 320: a shooting image is generated by using the current shooting parameters according to a received shooting instruction.

Step 330: if it is identified that a shooting abnormity occurs to the camera, a parameter adjustment reference is generated according to the shooting abnormity, and the parameter adjustment reference is sent to a cloud server in order to instruct the cloud server to generate a remote adjustment strategy according to the parameter adjustment reference.

The cloud server generates a remote adjustment strategy by performing expert system analysis via Big Data calculation and data analysis mining according to the received parameter adjustment reference, and the remote adjustment strategy is more preferred relative to the local adjustment strategy. Wherein, the parameter adjustment reference may include: parameters of the current shooting environment obtained by ISP of the camera, real-time data of a picture shot abnormally, parameters corresponding to shooting abnormity (for example, the number of abnormal shooting operations, user satisfaction data and shooting parameters of the current camera, etc.) or local adjustment strategy that is stored on the camera locally and corresponds to the shooting abnormity, etc.

Step 340: the remote adjustment strategy is received and taken as the setup parameter adjustment strategy.

Step 350: the current shooting parameters of the camera are adjusted based on a setup parameter adjustment strategy.

The current shooting parameters of the camera are adjusted according to the remote adjustment strategy received, so that a better shooting effect may be obtained.

In the method for adjusting shooting parameters of a camera according to the present embodiment, the parameter adjustment reference is sent to a cloud server, and the cloud server generates a remote adjustment strategy according to the received parameter adjustment reference, and hence the current shooting parameters of the camera will be adjusted according to the remote adjustment strategy, so that it may be better adapted for the shooting scenario, the shooting effect may be improved, and an image with which the user is satisfied may be shot, thereby improving user experience, and realizing an individualized shooting.

### Embodiment 4

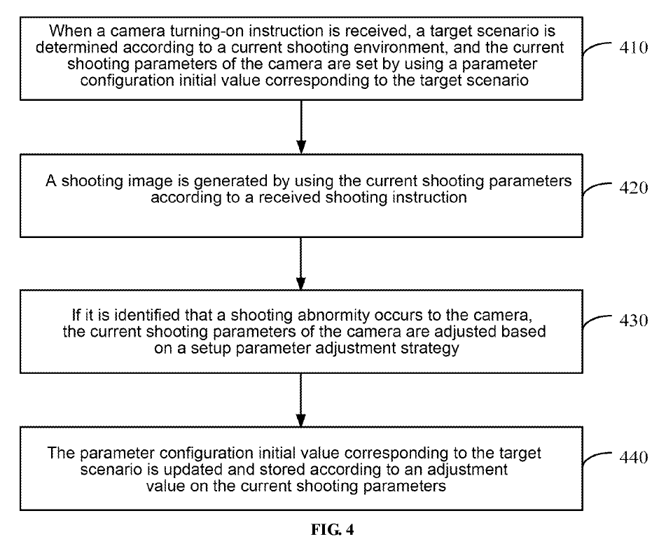

FIG. 4 is a flow chart of a method for adjusting shooting parameters of a camera according to Embodiment 4 of this disclosure. The present embodiment is optimized based on the above embodiments in order to enrich the parameter configuration initial values corresponding to the target scenario in the camera, so that the camera can be adapted for more shooting scenarios, thereby improving the shooting effect. The method includes the steps of:

Step 410: when a camera turning-on instruction is received, a target scenario is determined according to a current shooting environment, and the current shooting parameters of the camera are set by using a parameter configuration initial value corresponding to the target scenario.

Step 420: a shooting image is generated by using the current shooting parameters according to a received shooting instruction.

Step 430: if it is identified that a shooting abnormity occurs to the camera, the current shooting parameters of the camera are adjusted based on a setup parameter adjustment strategy.

Step 440: the parameter configuration initial value corresponding to the target scenario is updated and stored according to an adjustment value on the current shooting parameters.

In the solution for adjusting shooting parameters of a camera in the present embodiment, when it is identified that a shooting abnormity occurs to the camera, the current shooting parameters of the camera will be adjusted based on a setup parameter adjustment strategy, so that it may be adapted for the shooting scenario, the shooting effect may be improved, and the parameter configuration initial value corresponding to the target scenario is updated and stored according to an adjustment value on the current shooting parameters, thereby continuously enriching the parameter configuration initial values corresponding to the target scenario in the camera, and the camera can be adapted for more shooting scenarios, thereby realizing an individualized shooting.

### Embodiment 5

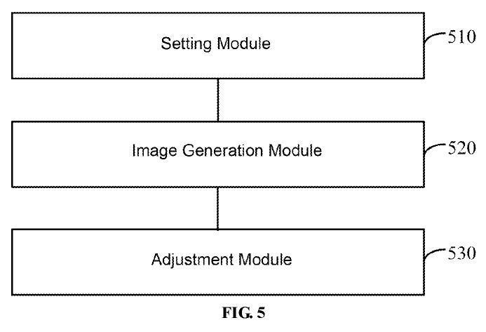

FIG. 5 is a block diagram of an electronic device for adjusting shooting parameters of a camera according to Embodiment 5 of this disclosure. Referring to FIG. 5, the electronic device includes: a setting module 510, an image generation module 520 and an adjustment module 530.

Where, the setting module 510 is configured for, when receiving a camera turning-on instruction, determining a target scenario according to the current shooting environment and setting the current shooting parameters of the camera by using a parameter configuration initial value corresponding to the target scenario; the image generation module 520 is configured for generating a shooting image by using the shooting parameters according to a received shooting instruction; and the adjustment module 530 is configured for, if it is identified that shooting abnormity occurs to the camera, adjusting the current shooting parameters of the camera based on a setup parameter adjustment strategy.

In the solution for adjusting shooting parameters of a camera according to this disclosure, when a camera turning-on instruction is received, a target scenario is determined according to the current shooting environment, the current shooting parameters of the camera are set by using the parameter configuration initial value corresponding to the target scenario in the system, and a shooting image is generated by using the initial shooting parameter, and when it is identified that shooting abnormity occurs to the camera, the current shooting parameters of the camera will be adjusted based on a setup parameter adjustment strategy, so that it may be adapted for the shooting scenario, the shooting effect may be improved, and an image with which the user is satisfied may be shot, thereby improving user experience, and realizing an individualized shooting.

Based on each of the above embodiments, the electronic device may further include: a sending module, which is configured for, if it is identified that a shooting abnormity occurs to the camera, generating a parameter adjustment reference according to the shooting abnormity, and sending the parameter adjustment reference to a cloud server in order to instruct the cloud server to generate a remote adjustment strategy according to the parameter adjustment reference; and a receiving module, which is configured for receiving the remote adjustment strategy as the setup parameter adjustment strategy.

Based on each of the above embodiments, the adjustment module 530 may be configured for: during the turning-on process of the camera, recording a total number of setup shooting operations of a user, wherein, the setup shooting operations include: a deleting operation and/or a saving operation of a user on the generated shooting image; and if the value of a first user satisfaction parameter determined via the number of setup shooting operations reaches a first user satisfaction threshold, determining that shooting abnormity is identified.

Based on each of the above embodiments, the electronic device may further include: an abnormal shooting image determination module, which is configured for, during the turning-on process of the camera, performing real-time data analysis on each of the generated shooting images and determining an abnormal shooting image.

Correspondingly, the adjustment module 530 may be configured for locally adjusting the current shooting parameters of the camera according to an abnormal parameter in the abnormal shooting image.

Based on each of the above embodiments, the abnormal shooting image determination module may include: an acquisition unit, which is configured for acquiring the value of a second user satisfaction parameter in each of the generated shooting images, wherein, the second user satisfaction parameter includes: the number of noises and/or a white balance; a determination unit, which is configured for taking a shooting image with the value of the second user satisfaction parameter reaching a second user satisfaction threshold the an abnormal shooting image, and taking the second user satisfaction parameter as the abnormal parameter.

Based on each of the above embodiments, the current shooting parameters of the camera may include: focal length, photosensibility, aperture size or shutter time.

Based on the above embodiments, the electronic device may further include: a storage module, which is configured for, after adjusting the current shooting parameters of the camera based on a setup parameter adjustment strategy, updating and storing the parameter configuration initial value corresponding to the target scenario according to an adjustment value on the current shooting parameters.

The above product may perform the method according to the embodiments of the disclosure, and it may have the corresponding functional modules and beneficial effects of the method performed.

### Embodiment 6

Embodiment 6 of this disclosure provides a non-transitory computer storage medium, on which a computer-executable instruction is stored, wherein the computer-executable instruction is configured for perform any of the above methods for adjusting shooting parameters of a camera according to this disclosure.

### Embodiment 7

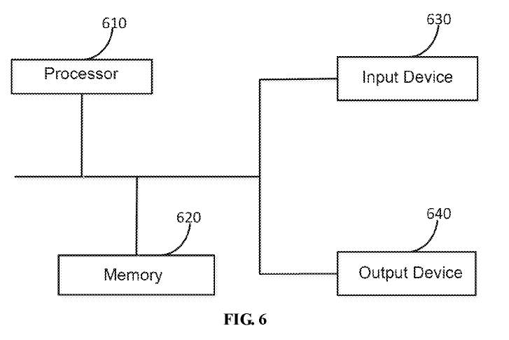

FIG. 6 is a schematic diagram showing the hardware structure of an electronic device according to Embodiment 7 of this disclosure. As shown in FIG. 6, the electronic device includes: one or more processors 610 and a memory 620; FIG. 6 shows an example in which the device includes one processor 610.

The terminal device may further include: an input device 630 and an output device 640.

The processor 610, the memory 620, the input device 630 and the output device 640 in the terminal device may be connected via a bus or in other manners. FIG. 6 shows an example in which they are connected via a bus.

As a non-transitory computer-readable storage medium, the memory 620 may be configured for storing a software program, a computer-executable program and a module, such as the program instruction/module corresponding to the method for adjusting shooting parameters of a camera in the embodiments of the disclosure (for example, the setting module 510, the image generation module 520 and the adjustment module 530 shown in FIG. 5). The processor 610 executes various functional application and data processing of a server by running the software programs, instructions and modules stored in the memory 620, thereby implementing the method for adjusting shooting parameters of a camera according to the above method embodiments.

The memory 620 may include a program storage region and a data storage region, where, the program storage region may be configured for storing an operating system and at least one functional application program; and the data storage region may be configured for storing the data created according to the use of a terminal device, etc. Additionally, the memory 620 may include a high random access memory, or it may further include a non-transitory memory, for example, at least one disk storage apparatus, flash memory apparatus or other non-transitory solid-state memory apparatuses. In some examples, the memory 620 may optionally include a memory set remotely relative to the processor 610, and such a remote memory may be connected to a terminal device via a network. An example of the above network includes, but is not limited to, Internet, Intranet, Local Area Network (LAN), Mobile Communication Network and a combination thereof.

The input device 630 may be configured for receiving the digit or character information input and generating a key signal input related to the user setting and function control of the terminal. The output device 640 may include a display device, such as a display screen.

The one or more modules are stored in the memory 620. When executed by the one or more processors 610, the one or more modules will perform the method according to any of the above method embodiments.

The above product may perform the method according to the embodiments of the disclosure, and it may have the corresponding functional modules and beneficial effects of the method performed. For the technical details that are not described fully in the present embodiment, reference may be made to the method provided in the present embodiments of the disclosure.

The electronic device in embodiments of this disclosure exists in various forms, including but not limited to:

(1) Mobile Telecommunication Device. A device of this kind has a feature of mobile communicating function, and has a main object of providing voice and data communication. Devices of this kind include smart phone (such as IPHONE), multi-media cell phone, functional cell phone, low-end cell phone and the like;

(2) Ultra Mobile Personal Computer Device. A device of this kind belongs to a category of personal computer, has functions of computing and processing, and generally has a feature of mobile Internet access. Devices of this kind include PDA, MID, UMPC devices and the like, such as IPAD;

(3) Portable Entertainment Device. A device of this kind can display and play multi-media content. Devices of this kind include audio and video player (such as IPOD), handheld game player, e-book, intelligent toy and portable vehicle navigation device;

(4) Server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) Other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for adjusting shooting parameters of a camera, which is applied to a terminal, comprising:
determining a target scenario according to a current shooting environment and setting current shooting parameters of the camera by using a parameter configuration initial value corresponding to the target scenario, when receiving a camera turning-on instruction;
generating a shooting image by using the current shooting parameters according to a received shooting instruction; and
adjusting the current shooting parameters of the camera based on a setup parameter adjustment strategy, when it is identified that a shooting abnormity occurs to the camera.

2. The method according to claim 1, wherein, when it is identified that a shooting abnormity occurs to the camera, the method further comprises:
generating a parameter adjustment reference according to the shooting abnormity, and sending the parameter adjustment reference to a cloud server to instruct the cloud server to generate a remote adjustment strategy according to the parameter adjustment reference; and
receiving and taking the remote adjustment strategy as the setup parameter adjustment strategy.

3. The method according to claim 1, wherein identifying the shooting abnormity of the camera comprises:
recording a total number of setup shooting operations of a user during the turning-on process of the camera, wherein, the setup shooting operations include: a deleting operation and/or a saving operation of the user on the generated shooting image; and
determining that the shooting abnormity is identified, if the value of a first user satisfaction parameter determined via the total number of setup shooting operations reaches a first user satisfaction threshold.

4. The method according to claim 3, further comprising: performing real-time data analysis on each of generated shooting images and determining an abnormal shooting image, during the turning-on process of the camera;
accordingly, the adjusting the current shooting parameters of the camera based on a setup parameter adjustment strategy specifically comprises:
locally adjusting the current shooting parameters of the camera according to an abnormal parameter in the abnormal shooting image.

5. The method according to claim 4, wherein, the performing real-time data analysis on each of the generated shooting images and determining an abnormal shooting image during the turning-on process of the camera comprises:
acquiring the value of a second user satisfaction parameter in each of the generated shooting images, wherein, the second user satisfaction parameter includes the number of noises and/or a white balance;
taking a shooting image with the value of the second user satisfaction parameter reaching a second user satisfaction threshold as the abnormal shooting image, and taking the second user satisfaction parameter as the abnormal parameter.

6. The method according to claim 1, wherein, the current shooting parameters of the camera comprise:
focal length, photosensibility, aperture size or shutter time.

7. The method according to claim 1, wherein, after adjusting the current shooting parameters of the camera based on a setup parameter adjustment strategy, the method further comprises:
updating and storing the parameter configuration initial value corresponding to the target scenario according to an adjustment value on the current shooting parameters.

8. A non-transitory computer storage medium, on which a computer-executable instruction is stored, wherein the computer-executable instruction is configured for:
determining a target scenario according to a current shooting environment and setting the current shooting parameters of the camera by using a parameter configuration initial value corresponding to the target scenario, when receiving a camera turning-on instruction;
generating a shooting image by using the current shooting parameters according to a received shooting instruction; and
adjusting the current shooting parameters of the camera based on a setup parameter adjustment strategy, when it is identified that shooting abnormity occurs to the camera.

9. The non-transitory computer storage medium according to claim 8, wherein, when it is identified that shooting abnormity occurs to the camera, the computer-executable instruction is further configured for:
generating a parameter adjustment reference according to the shooting abnormity, and sending the parameter adjustment reference to a cloud server in order to instruct the cloud server to generate a remote adjustment strategy according to the parameter adjustment reference; and
receiving and taking the remote adjustment strategy as the setup parameter adjustment strategy.

10. The non-transitory computer storage medium according to claim 8, wherein identifying the shooting abnormity of the camera comprises:
recording a total number of setup shooting operations of a user during the turning-on process of the camera, wherein, the setup shooting operations include: a deleting operation and/or a saving operation of a user on the generated shooting image; and
determining that the shooting abnormity is identified, if the value of a first user satisfaction parameter determined via the total number of setup shooting operations reaches a first user satisfaction threshold.

11. The non-transitory computer storage medium according to claim 10, wherein, the computer-executable instruction is further configured for:
performing real-time data analysis on each of the generated shooting images and determining an abnormal shooting image during the turning-on process of the camera;
accordingly, the adjusting the current shooting parameters of the camera based on a setup parameter adjustment strategy specifically comprises:
locally adjusting the current shooting parameters of the camera according to an abnormal parameter in the abnormal shooting image.

12. The non-transitory computer storage medium according to claim 11, wherein, the performing real-time data analysis on each of the generated shooting images and determining an abnormal shooting image during the turning-on process of the camera comprises:
acquiring the value of a second user satisfaction parameter in each of the generated shooting images, wherein, the second user satisfaction parameter includes the number of noises and/or a white balance; and
taking a shooting image with the value of the second user satisfaction parameter reaching a second user satisfaction threshold as the abnormal shooting image, and taking the second user satisfaction parameter as the abnormal parameter.

13. The non-transitory computer storage medium according to claim 8, wherein, the current shooting parameters of the camera comprise:
focal length, photosensibility, aperture size or shutter time.

14. An electronic device, comprising:
at least one processor; and
a memory communicably connected with the at least one processor for storing instructions executable by the at least one processor, wherein execution of the instructions by the at least one processor causes the at least one processor to:
determine a target scenario according to a current shooting environment and set the current shooting parameters of the camera by using a parameter configuration initial value corresponding to the target scenario, when receiving a camera turning-on instruction;
generate a shooting image by using the current shooting parameters according to a received shooting instruction; and
adjust the current shooting parameters of the camera based on a setup parameter adjustment strategy, when it is identified that a shooting abnormity occurs to the camera.

15. The electronic device according to claim 14, wherein, when it is identified that a shooting abnormity occurs to the camera, the execution of the instructions by the at least one processor further causes the at least one processor to:
generate a parameter adjustment reference according to the shooting abnormity, and send the parameter adjustment reference to a cloud server in order to instruct the cloud server to generate a remote adjustment strategy according to the parameter adjustment reference; and
receiving and taking the remote adjustment strategy as the setup parameter adjustment strategy.

16. The electronic device according to claim 14, wherein identifying the shooting abnormity of the camera comprises:
record a total number of setup shooting operations of a user during the turning-on process of the camera, wherein, the setup shooting operations include: a deleting operation and/or a saving operation of a user on the generated shooting image; and
determine that shooting abnormity is identified, if the value of a first user satisfaction parameter determined via the total number of setup shooting operations reaches a first user satisfaction threshold.

17. The electronic device according to claim 16, wherein, the execution of the instructions by the at least one processor further causes the at least one processor to:
perform real-time data analysis on each of the generated shooting images and determine an abnormal shooting image during the turning-on process of the camera;
accordingly, the adjust the current shooting parameters of the camera based on a setup parameter adjustment strategy specifically comprises:
locally adjust the current shooting parameters of the camera according to an abnormal parameter in the abnormal shooting image.

18. The electronic device according to claim 17, wherein, the perform real-time data analysis on each of the generated shooting images and determine an abnormal shooting image during the turning-on process of the camera comprises:
acquire the value of a second user satisfaction parameter in each of the generated shooting images, wherein, the second user satisfaction parameter includes the number of noises and/or a white balance; and
take a shooting image with the value of the second user satisfaction parameter reaching a second user satisfaction threshold as the abnormal shooting image, and taking the second user satisfaction parameter as the abnormal parameter.

19. The electronic device according to claim 14, wherein, the current shooting parameters of the camera comprise:
focal length, photosensibility, aperture size or shutter time.

20. The electronic device according to claim 14, wherein, after adjust the current shooting parameters of the camera based on a setup parameter adjustment strategy, the execution of the instructions by the at least one processor further causes the at least one processor to:
update and store the parameter configuration initial value corresponding to the target scenario according to an adjustment value on the current shooting parameters.
